(19) United States
(12) Patent Application Publication
(10) Pub. No.: US 2006/0236026 A1
(43) Pub. Date: Oct. 19, 2006

(54) Method and system for allocating, accessing and de-allocating storage space of a memory card

(76) Inventor: Jens Hempel, Tokyo (JP)

Correspondence Address: SLATER & MATSIL LLP, 17950 PRESTON ROAD, SUITE 1000, DALLAS, TX, 75252, US

(21) Appl. No.: 11/108,065

(22) Filed: Apr. 15, 2005

(51) Int. Cl. G06F 12/00

(52) U.S. Cl. 711/103; 711/115; 711/170

(57) ABSTRACT

A memory card includes a tamper resistant module with at least one first non-volatile memory module and a processor for the execution of multiple applications. The memory card also includes at least one second memory module external to said tamper resistant module and a memory management unit, which allocates blocks of memory from either the first or second memory module to the applications.

### TECHNICAL FIELD

The present invention relates generally to memory cards, and more particularly to a method and system for allocating, accessing and de-allocating storage space of a memory card.

### BACKGROUND

Non-volatile memory cards are increasingly replacing other forms of data storage. They are particularly useful for mobile applications, because they provide a high data capacity using only limited space and are insensitive to ambient magnetic fields and mechanical failures.

Unlike conventional storage media, like optical disks or magnetic tapes, memory cards comprise a card internal controller, which controls the access to card internal memory modules. This allows one to securely store data on a memory card without exposing the data to every host system, to which the memory card is connected.

It is known to use memory cards for the secure storage of sensitive data of applications such as copyright protected music or other media files, personal keys used for encryption and decryption or individual access codes. Memory cards used for the secure storage of data are known from the PCT Patent Publication WO 02/075505, and corresponding U.S. Patent Application Publication No. 2005/0055561, which are incorporated herein by reference.

Access to parts or all of the contents of a memory card can be restricted, for example by the use of access certificates, which are sent from a host system to the memory card and are verified by the memory card's controller using data securely stored on the memory card.

It is further known to integrate a non-volatile memory module for storing such sensitive data into a tamper resistant module (TRM), such that unauthorized access to the data is extremely difficult. Tampering with the contents of a TRM can be prevented for example by observing the signal levels of lines from and to the TRM. In this way, tampering with a TRM or its signal lines can be detected and sensitive data can be deleted before it can be accessed by an unauthorized system or person. Other examples of tamper protection are to generate a current profile independent from the external current consumption or to provide an active shield.

It is a disadvantage of the known prior art that the distribution of protected and unprotected data is fixed by the physical setup of the memory card, with the protected data being stored inside the TRM and the unprotected data being stored in another non-volatile memory module.

### SUMMARY OF THE INVENTION

Accordingly, in one aspect the current invention describes a memory card in which confidential and non-confidential data of applications can be distributed in a more flexible way.

According to embodiments of the current invention, a method is provided for the dynamic allocation and de-allocation of storage space to applications of a memory card. A further method is provided for the access to the dynamically allocated memory by the applications. The methods according to embodiments of the invention are carried out using a memory card with a tamper resistant module comprising a processor and a first non-volatile memory module and a plurality of the applications executable in the processor. The memory card further comprises a protocol adapter for providing access to an external host system, a second non-volatile memory module and a memory management unit, comprising an allocation unit, allocating blocks of memory from the first and the second non-volatile memory modules to the plurality of applications. The memory management unit provides an open and a secure interface for allocating and accessing blocks of memory, the secure interface allowing to specify request for protected or unprotected storage.

According to embodiments of the invention, the blocks of memory are organized on two different levels. On a first level, the physical level, they are organized by their physical locations, i.e., if they belong to the first non-volatile memory module comprised in the tamper resistant module or if they belong to the second non-volatile memory module outside the tamper resistant module. On the second level, the logical level, the blocks of memory are organized in slices assigned to different applications. Each block of memory is either marked as being free or allocated to a particular slice and thus application. Only this particular application running in the processor of the tamper resistant module can access the block of memory allocated to it. In this way, multiple applications can be loaded onto a single memory card without interfering with each other.

The memory management unit can be accessed using two different interfaces. The first interface, the open interface, can be used by legacy applications, i.e., applications written before the introduction of secure storage on memory cards, and applications not making use of secure storage. Requests for blocks of memory submitted to the open interface cannot access memory being allocated to any of the secure applications. Typically, requests to the open interface will be served by blocks of memory from the non-volatile memory module outside the TRM. The open interface is also accessible by the protocol adapter of the memory card, and thus allows to forward requests from an external host system to the memory card.

The second interface of the memory management unit, the secure interface, allows secure applications running inside the TRM to choose to request either protected storage or unprotected storage. Protected storage space is always provided from blocks of memory located inside the TRM. Blocks of memory for unprotected storage of a secure application can be provided by the non-volatile memory module outside the TRM as well as the non-volatile memory module inside the TRM. The decision as to which non-volatile memory module to use is made by the memory management unit and depends on the availability of blocks of memory in either non-volatile memory module.

Unprotected storage space is cheaper than protected storage space. Therefore, it is preferred to use the storage space of the unprotected memory modules outside the TRM unless secure storage space is required. In addition, access speed to the memory module integrated into the TRM is usually slower than access to the external memory module.

As an additional advantage, the method according to embodiments of the invention is capable of distributing the memory of both non-volatile memory modules between different applications and thus provides an easy means of multiple application loading on a secure memory card.

Also, by allowing an individual application to specify the amount of protected and unprotected storage it requires, it is possible to load secure applications, whose memory requirements could not be satisfied by secure memory cards according to the prior art. To this end, only the secure data of the application is loaded into the protected storage, while additional data with no demand for active protection is loaded into the unprotected storage area. For example, encrypted files could be stored in the unprotected storage area as long as the keys required for their decryption are stored securely in the protected storage area.

### BRIEF DESCRIPTION OF THE DRAWINGS

The present invention is best understood by the means of exemplary embodiments. The embodiments will be presented using the figures described below.

FIG. 1 shows a schematic diagram of a memory card according to a first embodiment of the invention, comprising a tamper resistant module including a non-volatile memory module inside the tamper resistant module and another non-volatile memory module outside the tamper resistant module;

FIG. 2 shows the relationships of the different interfaces of the memory management unit and an exemplary configuration of blocks of memory of a first and second non-volatile memory module;

FIG. 3 shows a flow chart of an inventive method for allocating storage space of a memory card;

FIG. 4 shows a flow chart of an inventive method for accessing storage space of a memory card; and

FIG. 5 shows a second embodiment of the current invention, which comprises an integrated circuit with a tamper resistant module and an integrated protocol adapter.

### DETAILED DESCRIPTION OF ILLUSTRATIVE EMBODIMENTS

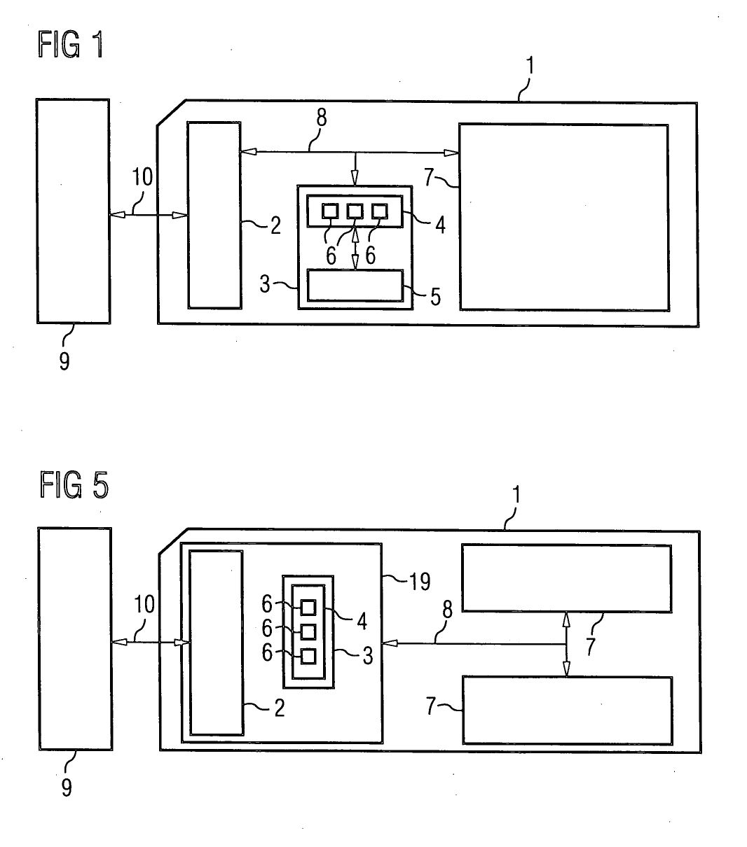

FIG. 1 shows a memory card 1. The memory card 1 comprises a protocol adapter 2 and a tamper resistant module 3. The protocol adapter 2 comprises a controller (not shown) and other components required for data exchange between an external host system 9 and the memory card 1 through an interface 10. The tamper resistant module 3 comprises a processor 4 and a first non-volatile memory module 5. The processor 4 comprises three applications 6, which are being executed inside the processor 4. The memory card 1 further comprises a second non-volatile memory module 7. The protocol adapter 2, the tamper resistant module 3 and the second non-volatile memory module 7 are connected by a communication bus 8.

The host system 9 can access the second non-volatile memory module 7 using the interface 10, the protocol adapter 2 and the communication bus 8. However, the first non-volatile memory module 5 can only be accessed by the processor 4 contained in the tamper resistant module 3. For this reason, only applications 6 running inside the processor 4 can access an allocated part of the first non-volatile memory module 5.

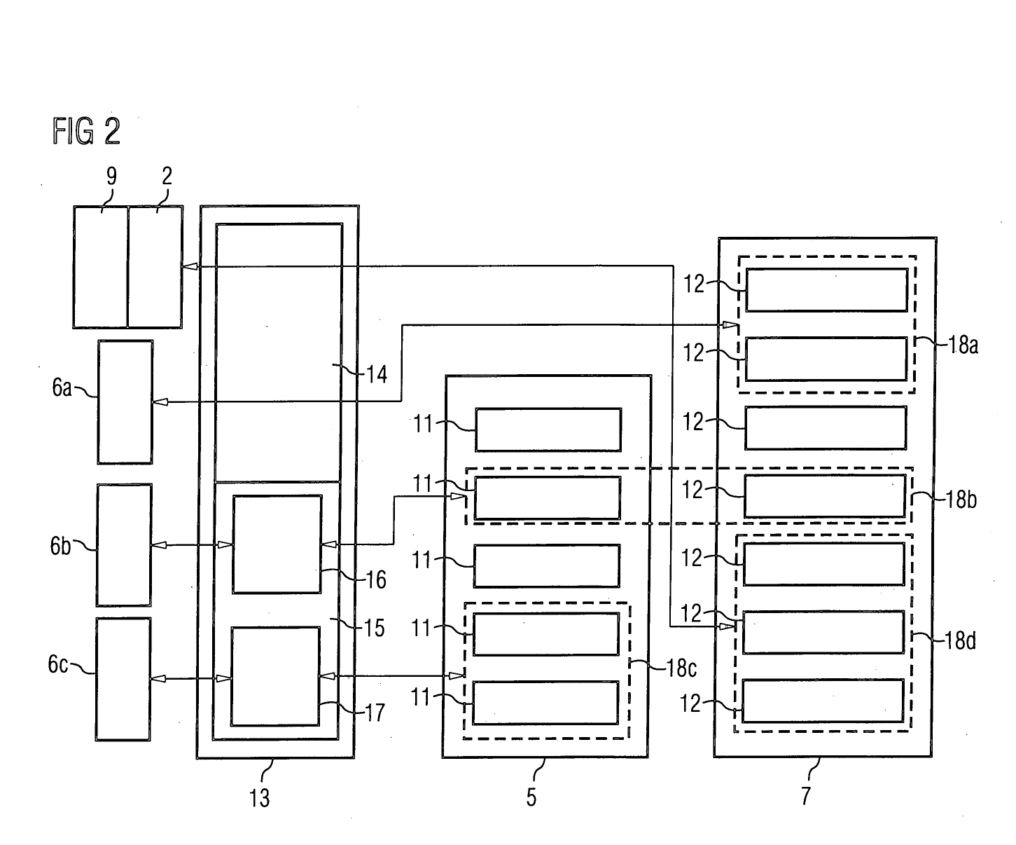

FIG. 2 shows an exemplary configuration of a memory card 1 comprising a first non-volatile memory module 5 and a second non-volatile memory module 7. The first non-volatile memory module 5 comprises five blocks of memory 11. The second non-volatile memory module 7 comprises seven blocks of memory 12. FIG. 2 further shows a memory management unit 13, comprising an open interface 14 and a secure interface 15. The open interface 14 can be accessed by the protocol adapter 2 and the applications 6. The secure interface 15 can only be accessed by the applications 6, either in an unprotected mode 16 or a protected mode 17.

The memory management unit 13, or memory management means, can be implemented in hardware or as a software process as part of the protocol adapter 2 or the tamper resistant module 3. In an advantageous embodiment, the open interface 14 is provided by the protocol adapter 2, in order to provide direct access to the second memory module 7, while the secure interface 15 is provided by the tamper resistant module 3.

Three different applications 6 access memory using the memory management unit 13. A first application 6a is using the open interface 14 of the memory management unit 13. It is allocated a slice of memory 18a, which is entirely contained in the second non-volatile memory module 7. The second application 6b is addressing a slice of memory 18b using the unprotected mode 16 of the secure interface 15. The slice of memory 18b being allocated to the second application 6b comprises a block of memory 11 from the first non-volatile memory module 5 and a block of memory 12 from the second non-volatile memory module 7. The third application 6c is accessing a slice of memory 18c using the protected mode 17 of the secure interface 15 of the memory management unit 13. The slice of memory 18c allocated to the third application 6c comprises only blocks of memory 11 from the first non-volatile memory module 5.

A fourth access path is provided for the external host system 9, accessing the second memory module 7 by means of the protocol adapter 2 and the open interface 14 of the memory management unit 13. According to FIG. 1 the protocol adapter 2 can directly access the second memory module 7, which allows fast access compared with access through the tamper resistant module 3. However, only access to the second memory module 7 is possible. In the exemplary configuration, three contiguous blocks of memory 12 from the second memory module 7 are comprised in a slice of memory 18d, which is allocated to the protocol adapter 2. Different applications running on a host system 9 can share this slice of memory 18d. Typically, it will comprise most of the blocks of memory 12 of the second memory module 7.

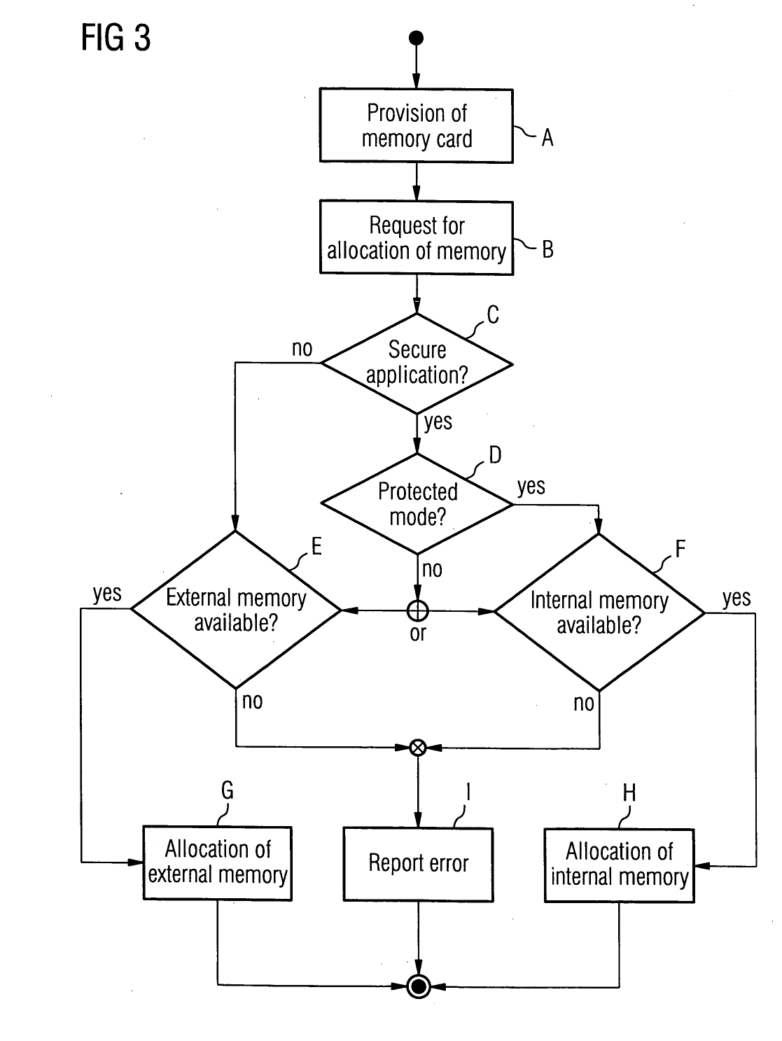

FIG. 3 shows a flowchart of the memory allocation method. In a first step A the memory card is provided. In the given example, the memory card 1 comprises a tamper resistant module 3, comprising a first non-volatile memory module 5 and a processor 4 for the execution of secure application 6, and a second non-volatile memory module 7. The memory card 1 further comprises a memory management unit 13 and a protocol adapter 2.

In step B one of the applications 6 requests a slice of memory 18. The size of the slice of memory 18 can be specified by the application 6 or be a standard value, e.g., a size corresponding to the physical organization of the memory modules 5 and 7. The request of the application 6 is sent either to the secure interface 15 or the open interface 14 of the memory management unit 13. In step C the memory management unit 13 checks which interface 14 or 15 was used by the requesting application 6, i.e., whether the application 6 is secure or not. Secure application 6 will typically use the secure interface 15 of the memory management unit 13. Insecure or conventional applications, which are not aware of the extended functionality of the memory management unit 13, will always request memory from the open interface 14.

In an advantageous embodiment of the invention the open interface 14 is backward compatible to existing standards for memory cards, e.g., to the SD Card (Secure Digital Card) or miniSD Card, the Multi Media Card (MMC), the Memory Stick, the Compact Flash (CF) card standard or the Universal Serial Bus (USB) standard. In such an embodiment, an external host system 9 can access the blocks of memory 12 of the second non-volatile memory module 7, which are not allocated to a card-internal application 6, like a conventional memory card. This can be achieved, for example, by forwarding access requests from the external host system 9 sent to the protocol adapter 2 to the open interface 14 of the memory management unit 13.

If a secure application 6 is requesting a slice of memory 18 using the secure interface 15, a further check is performed in step D checking whether the memory was requested in the unprotected mode 16 or the protected mode 17, i.e., whether the application 6 intends to store sensitive data in the allocated memory.

If a slice of memory 18 was requested using the open interface 14 of the memory management unit 13, the memory management unit 13 will check whether memory in the second non-volatile memory module 7 is available for allocation. This check is performed in step E. If a slice of memory 18 was requested using the protected mode 17 of the secure interface 15, the memory management unit 13 will check if blocks of memory 11 of the first non-volatile memory module 5 are available. This test is performed in step F. If a slice of memory 18 was requested using the unprotected mode 16 of the secure interface 15, the memory management unit 13 will check in step F or E if either blocks of memory 11 from the first non-volatile memory module 5 or blocks of memory 12 from the second non-volatile memory module 7 are available for allocation.

In this case steps E and F can be executed in parallel or subsequently, according to a strategy implemented by the memory management unit 13. For example, the memory management unit 13 could always try to allocate blocks of memory 12 from the second memory module 7. This strategy has the advantage, that memory accesses to the second memory module 7 are typically faster than those to the first memory module 5 contained in the tamper resistant module 3.

Alternatively the memory management unit 13 could try to use only the first or second memory module 5 or 7, such that the entire slice of memory 18 is located in subsequent blocks of memory 11 or 12 of the first or second memory module 5 or 7. This strategy avoids needless fragmentation of the slices of memory 18 into blocks of memory 11 or 12 of the first or second memory module 5 or 7. Only if neither the first nor the second memory module 5 or 7 can provide sufficient blocks of memory 11 or 12, a combination of blocks 11 and 12 from both memory modules 5 and 7 would be used in this strategy.

If the test of step E is successful, i.e., if external memory is available for allocation, one or more blocks of memory 12 from the second non-volatile memory module 7 are combined to form a slice of memory 18 and are allocated to the requesting application 6 in step G. Similarly, if internal memory was requested using the secure interface 15 and is available for allocation, in step H one or more blocks of memory 11 from the first non-volatile memory module 5 are combined to form a slice of memory 18 and allocated to the requesting application 6. In the case of a request using the unprotected mode 16 of the secure interface 15, blocks of memory 11 and 12 from the first and second memory modules 5 and 7 can be combined in a slice of memory 18. Of course, all blocks of memory 11 or 12 for such a request can also be provided by either the first or the second memory module 5 or 7.

A special case of the memory allocation process performed in step G is the initial memory allocation performed by the card manufacturer or provider. Typically, during such a card initialization all or at least a significant part of the blocks of memory 12 of the second memory module 7 will be allocated to the special application provided by the protocol adapter 2. That means that unless any secure applications 6 are loaded into the tamper resistant module 3, all or most external storage space is accessible to an external host system 9.

In the case, where only insufficient blocks of memory 11 or 12 are available for allocation to a requesting application 6, the memory management unit 13 will report an error to the requesting application 6 in step I.

In an advantageous embodiment, the memory management unit 13 will try to allocate subsequent blocks of memory 11 or 12 to a slice of memory 18 in order to improve the access speed to the slice of memory 18. If only insufficient subsequent free blocks of memory 11 or 12 are available for an allocation request, the memory management 13 will attempt to reorganize the first or second memory module 5 or 7 by moving and thus regrouping blocks of memory 11 or 12 inside the memory module 5 or 7. Such reorganization methods are known for example from defragmentation programs used for optimizing the access speed to hard disk drives.

In a further embodiment, the memory management unit 13 provides a function that allows a card internal application 6 to release or shrink a slice of memory 18. The blocks of memory 11 or 12 comprised in the released slice of memory 18, or those that are comprised in the released part of the slice of memory 18, are marked as free blocks of memory 11 or 12 by the memory management unit 13. This allows, for example, to unload applications 6, which are no longer required, or to delete data, which is not needed anymore, like expired certificates or license keys.

In yet another embodiment, all blocks of memory 12 of the second memory module 7, which are not allocated to a card internal application 6, are allocated to one special slice of memory 18 made available by the open interface 14 of the memory management unit 13 and exposed to an external host system 9 using the protocol adapter 2 and the interface 10. Alternatively the unallocated, i.e., the free blocks of memory 12 are reported as free space to a host system 9. In either case, the memory management unit 13 decreases the amount of memory available to an external host system 9, if blocks of memory 12 are allocated to a card internal application 6, and increases the amount of memory available to a host system 9, if blocks of memory 12 are released by a card internal application 6 as described above.

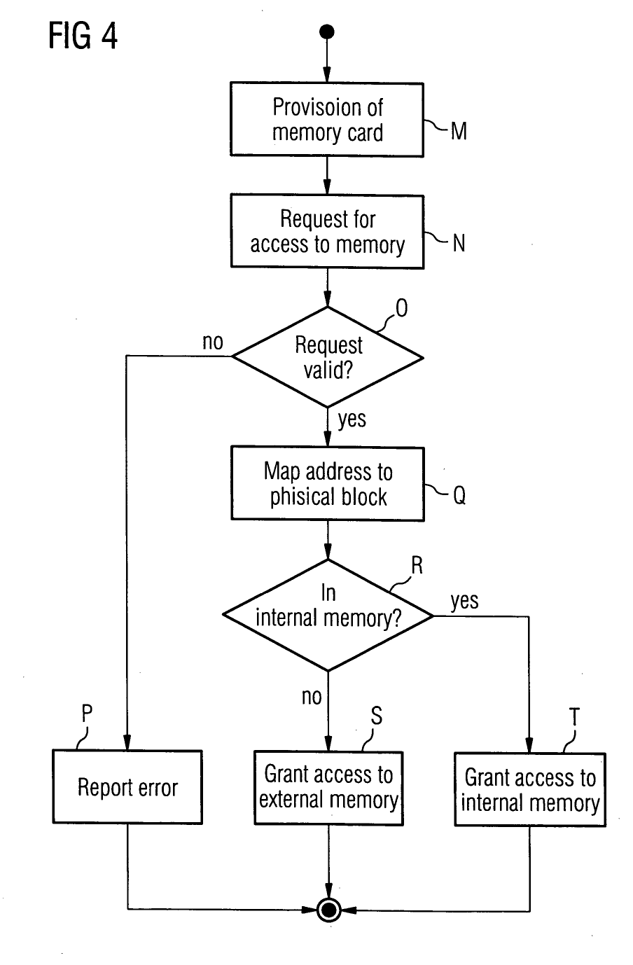

FIG. 4 shows a flowchart for the method for accessing memory. In step M, a memory card 1 is provided. The memory card 1 comprises the same components as the memory card 1 provided in step A of FIG. 3. The blocks of memory 11 or 12 from the first non-volatile memory module 5 and the second non-volatile memory module 7 have been allocated to slices of memory 18 of applications 6 using the method for allocating storage space described above.

In step N, an application 6 requests access to a slice of memory 18 of the memory card 1. The request is directed to the memory management unit 13.

In a step O, the memory management unit 13 checks whether the request sent by the application 6 is valid. Particularly, the memory management unit 13 tests whether the requested slice of memory 18 is allocated to the requesting application 6, e.g., by using a mapping table showing the application 6 allocated with each slice of memory 18. If the request is invalid for the application 6, an error will be reported and access to the memory slice 18 will be prevented in step P.

If the request of the application 6 is valid, the request for access to the slice of memory 18 is mapped in step Q to one or multiple blocks of memory 11 or 12 either in the first non-volatile memory module 5 or the second non-volatile memory module 7 or both by the memory management unit 13. If the request is mapped to a block of memory 11 of the first non-volatile memory module 5, access is granted to the mapped block or blocks of memory 11 in the internal, first non-volatile memory module 5 in step T. If the request of the application 6 is mapped to one or several blocks of memory 12 of the external second non-volatile memory module 7, then access is granted to the mapped block or blocks of memory 12 of the external, second non-volatile memory module 7 in step S.

In case of granting access to a slice of memory 18, which comprises blocks of memory 11 and 12 from the first and second memory modules 5 and 7, steps S and T are both executed, either in parallel or one after the other.

FIG. 5 shows another embodiment of a memory card 1 according to embodiments of the invention. The memory card 1 comprises an integrated circuit 19 comprising a protocol adapter 2 for providing access to the memory card 1 and a tamper resistant module 3. The memory card 1 further comprises two memory modules 7, both external to the integrated circuit 19. The tamper resistant module 3 comprises a processor 4 for the execution of card internal applications 6. The integrated circuit 19 is connected to the memory modules 7 using a data bus 8 and to an external host system 9 using an interface 10.

The embodiment presented in FIG. 5 differs from the previous embodiments in several aspects. Though all aspects are shown in a single embodiment, it should be understood that each of these variations is independent of each other and that they do not need to occur in combination. A person skilled in the art will notice that each of the presented aspects and many more can be applied to the current invention without departing from the inventive concept.

Firstly, the protocol adapter 2 and the tamper resistant module 3 are integrated into a single integrated circuit 19. In general, all card internal components can be manufactured as separate electronic components or integrated into one or a few integrated circuits. For example, the protocol adapter 2 may be composed of a controller and a separate memory interface and a host interface component, or all these components may be integrated into a single integrated circuit.

Secondly, the tamper resistant module 3 of FIG. 5 does not comprise an internal memory module 5. Thus, the memory management unit 13 of the memory card 1 does not offer a protected mode 17 through its secure interface 15. Alternatively, the memory management unit 13 can offer a protected mode 17, but it always reports no free blocks of memory 11 and reports an error if an application 6 requests allocation of a protected slice of memory 18. Nevertheless, the memory management unit 13 can still provide a secure interface 15 for the allocation of unprotected storage. In addition the memory management unit 13 can still allocate different slices of memory 18 to different applications 6, such that the applications 6 cannot disturb each other or overwrite data that is allocated to another application 6.

In an alternative embodiment, the opposite configuration can be used, i.e., a memory card 1 comprising a first memory module 5 internal to a tamper resistant module 3, but no external, second memory module 7. In this case, only application requests to the secure interface 15 of the memory management unit 13 can be served, while the protocol adapter 2 always reports no available memory to an external host system 9 or insecure application 6.

At last, the memory card 1 of FIG. 5 comprises two external memory modules 7. In practice, the memory card 1 can comprise any number of memory modules 7, according to the desired capacity.

Although specific embodiments have been illustrated and described herein, it will be appreciated by those skilled in the art that any arrangement that is calculated to achieve the same purpose may be substituted for the specific embodiments shown. Many adaptations, which do not depart from the inventive concept, will be apparent to those skilled in the art. Accordingly, this application is intended to cover any adaptations or variations of the present invention. It is manifestly intended that this invention be limited only by the following claims and equivalents thereof.

What is claimed is:

1. A method for operating a memory card, the method comprising:
receiving a request from an application to access at least one block of memory, the request being received using either an open interface or a secure interface; and
allocating at least one previously unallocated block of memory to the requesting application, the unallocated block of memory being from:
a first non-volatile memory module if protected storage was requested using the secure interface, the first non-volatile memory module being located in a tamper resistant module;
a second non-volatile memory module if storage was requested using the open interface; or
either the first non-volatile memory module or the second non-volatile memory module if unprotected storage was requested using the secure interface.

2. The method according to claim 1, further comprising providing a memory card, the memory card comprising:
the tamper resistant module;
a processor within the tamper resistant module, the application being executable in the processor;
the second non-volatile memory module; and
a memory management unit that includes an allocation unit to allocate blocks of memory from at least the first or the second non-volatile memory modules to the application, the memory management unit providing the open interface and the secure interface for accessing blocks of memory, the secure interface operable to specify requests for protected or unprotected storage.

3. The method according to claim 2, further comprising:
requesting access from a requesting application to at least one block of memory using either the open interface or the secure interface, the access being requested through the memory management unit and the requesting application being executed in the processor;
checking whether the requested block is allocated to the requesting application;
mapping the request from the requesting application to a block of memory of the first memory module or the second memory module, if the requested block is mapped to the requesting application; and
providing access to the mapped block of memory of the first memory module or the second memory module to the requesting application.

4. The method according to claim 2, further comprising:
receiving a request for de-allocation of at least one block of memory by a requesting application, the request received using either the open interface or the secure interface and the requesting application being executed in the processor;
checking whether the requested block is allocated to the requesting application;
mapping of the request from the application to at least one block of memory of the first memory module or the second memory module, if the requested block is mapped to the requesting application; and
releasing the mapped block of memory of the first memory module or the second memory module from the requesting application and marking them as free.

5. The method according to claim 1, further comprising:
requesting access from a requesting application to at least one block of memory using either the open interface or the secure interface;
checking whether the requested block is allocated to the requesting application;
mapping the request from the requesting application to a block of memory of the first memory module or the second memory module, if the requested block is mapped to the requesting application; and
providing access to the mapped block of memory of the first memory module or the second memory module to the requesting application.

6. The method according to claim 1, further comprising:
receiving a request for de-allocation of at least one block of memory by a requesting application, the request received using either the open interface or the secure interface;
checking whether the requested block is allocated to the requesting application;
mapping of the request from the application to at least one block of memory of the first memory module or the second memory module, if the requested block is mapped to the requesting application; and
releasing the mapped block of memory of the first memory module or the second memory module from the requesting application and marking them as free.

7. The method according to claim 1, further comprising:
receiving a request from an external host system to access blocks of memory; and
allocating at least one previously unallocated block of memory to the external host system, the unallocated block of memory being allocated from the second non-volatile memory module.

8. The method according to claim 7, wherein the memory module comprises a protocol adapter and wherein the request from the external host system is received through the protocol adapter.

9. The method according to claim 8, wherein the protocol adapter only grants the external host system access to blocks of memory located in the second memory module, which are not being allocated to any memory card internal applications.

10. A memory card comprising:
a tamper resistant module comprising a processor for the execution of memory card internal applications and a first non-volatile memory module that includes a plurality of blocks of memory;
a second non-volatile memory module that includes a plurality of blocks of memory; and
a memory management unit operable to allocate blocks of memory from at least the first or the second non-volatile memory modules to the memory card internal applications, the memory management unit providing an open interface and a secure interface for accessing blocks of memory, the secure interface operable to specify requests for protected or unprotected storage.

11. The memory card according to claim 10, wherein the memory management unit comprises an allocation unit, the allocation unit operable to allocate blocks of memory from at least the first or the second non-volatile memory modules to the memory card internal applications.

12. The memory card according to claim 10, further comprising a protocol adapter for accessing the contents of the memory card from a host system connected to the protocol adapter by means of an interface.

13. The memory card according to claim 12, wherein the protocol adapter only grants an external host system access to blocks of memory comprised in the second memory module, which are not being allocated to any memory card internal applications.

14. The memory card according to claim 13, wherein the protocol adapter is configured to comply with at least one of the following specifications: Secure Digital Card (SD Card), miniSD, Multi Media Card (MMC), Memory Stick, Compact Flash (CF), and Universal Serial Bus (USB).

15. The memory card according to claim 12, wherein the protocol adapter is configured to comply with at least one of the following specifications: Secure Digital Card (SD Card), miniSD, Multi Media Card (MMC), Memory Stick, Compact Flash (CF), and Universal Serial Bus (USB).

16. A method for allocating storage space in a memory card, the method comprising:
providing a memory card, the memory card comprising:
a tamper resistant module comprising a processor and a first non-volatile memory module, the first non-volatile memory module comprising a plurality of blocks of memory, at least one application being executable in said processor;
a second non-volatile memory module comprising a plurality of blocks of memory;
a memory management unit comprising an allocation unit allocating blocks of memory from at least said first or said second non-volatile memory modules to said at least one application, said memory management unit providing an open and a secure interface for accessing blocks of memory, said secure interface allowing to specify requests for protected or unprotected storage;
requesting at least one block of memory from the memory management unit by said at least one application using either the open or the secure interface; and
allocating at least one previously unallocated block of memory to the requesting application by the memory management unit:
from the first non-volatile memory module, if protected storage was requested using the secure interface;
from either the first or the second non-volatile memory module, if unprotected storage was requested using the secure interface; or
from the second non-volatile memory module, if storage was requested using the open interface.

17. The method according to claim 16, further comprising:
requesting access to at least one block of memory from the memory management unit by said at least one application using either the open or secure interface;
checking whether the requested block is allocated to the requesting application;
mapping the request from said application to a block of memory of said first memory module or said second memory module, if the requested block is mapped to the requesting application; and
providing access to the mapped block of memory of the first memory module or the second memory module to the requesting application.

18. The method according to claim 16, further comprising:
requesting de-allocation of at least one block of memory from the memory management unit by said at least one application using either the open or secure interface;
checking whether the requested block is allocated to the requesting application;
mapping the request from said application to at least one block of memory of said first memory module or said second memory module, if the requested block is mapped to the requesting application; and
releasing the mapped block of memory of the first memory module or the second memory module from the requesting application and marking them as free.

19. The method according to claim 18, further comprising erasing the mapped block of memory in response to the request for de-allocation.

20. The method according to claim 16, wherein the second memory module is external to the tamper resistant module.
